(19) United States
(12) Patent Application Publication
(10) Pub. No.: US 2014/0053817 A1
(43) Pub. Date: Feb. 27, 2014

(54) INTERNAL COMBUSTION ENGINE

(71) Applicant: DENSO CORPORATION, Kariya-city (JP)

(72) Inventors: Takamasa YOKOTA, Kariya-city (JP); Satoru SASAKI, Kariya-city (JP)

(73) Assignee: DENSO CORPORATION, Kariya-city (JP)

(21) Appl. No.: 13/958,914

(22) Filed: Aug. 5, 2013

(30) Foreign Application Priority Data
Aug. 21, 2012 (JP) 2012-182319

(51) Int. Cl. F02M 25/07

(52) U.S. Cl. CPC F02M 25/07
USPC 123/568.11

(57) ABSTRACT

A variable-valve-mechanism controlling portion controls a variable valve mechanism in such a manner that an exhaust valve is opened not only in an exhaust stroke but also in an intake stroke. In the intake stroke, a part of the exhaust gas discharged from the combustion chamber is returned to the combustion chamber along with an intake air flowing through the intake passage. A fluid injector injects a non-combustible fluid including water into the exhaust gas discharged from the combustion chamber. In the intake stroke, the exhaust gas introduced into the combustion chamber from the exhaust passage contains a water vapor evaporated from the non-combustible fluid. The exhaust gas discharged from the combustion chamber in the exhaust stroke includes the non-combustible fluid and is returned to the combustion chamber in a successive intake stroke.

### CROSS-REFERENCE TO RELATED APPLICATION

This application is based on Japanese Patent Application No. 2012-182319 filed on Aug. 21, 2012, the disclosure of which is incorporated herein by reference.

### TECHNICAL FIELD

The present disclosure relates to an internal combustion engine.

### BACKGROUND

It is well known that water is added into a combustion chamber of an internal combustion engine in order to decrease a combustion temperature in the combustion chamber, whereby nitrogen oxides (NOx) contained in an exhaust gas is significantly decreased. As the water quantity supplied to the combustion chamber is more increased, NOx contained in the exhaust gas is more decreased. In order to increase the water quantity, it is necessary to accelerate a vaporization of the water. The NOx quantity contained in the exhaust gas depends on the added water quantity. Thus, it is necessary that the water quantity is quickly determined based on the fuel injection quantity. It is preferable that the combustion chamber and a water supply position are close to each other as much as possible.

JP-11-82182A and JP-2005-147046A show an engine to which water is supplied. In JP-11-82182A, the water is added to an intake air flowing through an intake passage or an exhaust gas recirculation (EGR) passage. The added water is suctioned in to the combustion chamber along with the intake air flowing through the intake passage and the exhaust gas flowing through the EGR passage. However, since the water is added to the intake air or the exhaust gas passed through an EGR cooler, the vaporization of the water is insufficient. As a result, the water quantity suctioned into the combustion chamber is decreased, and the reduction effect of NOx is not high. In a case that the water is added to the intake air or the EGR gas as shown in JP-11-82182A, the added water is suctioned into the combustion chamber in an intake stroke after some combustion cycles are performed. Therefore, the responsiveness for controlling NOx is deteriorated.

JP-2005-147046A shows that the water is directly added to the combustion chamber, so that the added water quantity is easily controlled and the responsiveness for controlling NOx is improved. However, in order to add the water into the combustion chamber directly, it is necessary to provide the water of which pressure is greater than that of the compressed high-pressure intake air. Thus, a mechanism for adding the water becomes complicate.

### SUMMARY

It is an object of the present disclosure to provide an internal combustion engine which is capable of reducing NOx contained in an exhaust gas with high responsiveness without causing a complication of its structure.

According to the present disclosure, an exhaust-valve control portion controls an opening-and-closing time of an exhaust valve. That is, when a combustion chamber is in an exhaust stroke, the exhaust-valve control portion opens the exhaust valve to connect the combustion chamber to an exhaust passage. When the combustion chamber is in an intake stroke, the exhaust-valve control portion opens the exhaust valve again to connect the combustion chamber to an exhaust passage. A fluid injector is arranged downstream of the exhaust valve in the exhaust gas flow direction. The fluid injector injects a non-combustible fluid including water into the exhaust gas discharged from the combustion chamber. The exhaust gas to which the non-combustible fluid is added is introduced into the combustion chamber through the exhaust passage when the exhaust valve is opened. That is, not only a fresh air but also the exhaust gas including the non-combustible fluid are introduced into the combustion chamber. The exhaust gas immediately after discharged from the combustion chamber to the exhaust passage is of high temperature. Therefore, the water included in the non-combustible fluid is vaporized enough by the exhaust gas. Sufficient quantity of the vaporized water is introduced into the combustion chamber. An exhaust gas pressure in the exhaust passage is lower than that in the combustion chamber. Thus, it is unnecessary to increase a non-combustible fluid pressure to be added into the exhaust gas. A configuration of the non-combustible fluid supply portion can be simplified. Moreover, the non-combustible fluid is returned to the combustion chamber along with the exhaust gas. That is, after the non-combustible fluid is added to the exhaust gas, the exhaust gas flows back to the combustion chamber. Therefore, the water contained in the non-combustible fluid is introduced into the combustion chamber along with the exhaust gas in a successive intake stroke.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view showing a configuration of an internal combustion engine according to a first embodiment;

FIG. 2 is a block chart showing the internal combustion engine according to the first embodiment;

FIG. 3 is a flowchart showing an operation of the internal combustion engine according to the first embodiment;

FIG. 4 is a schematic chart showing a combustion chamber pressure, an operation of a fluid injector, and opening-and-closing times of an intake valve and an exhaust valve during an exhaust stroke;

FIG. 5 is a schematic chart showing a combustion chamber pressure, an operation of a fluid injector, and opening-and-closing times of an intake valve and an exhaust valve during an intake stroke;

FIG. 6 is a schematic chart showing a combustion chamber pressure, an operation of a fluid injector, and opening-and-closing times of an intake valve and an exhaust valve during a compression stroke;

FIG. 7 is a schematic chart showing a combustion chamber pressure, an operation of a fluid injector, and opening-and-closing times of an intake valve and an exhaust valve during a power stroke;

FIG. 8 is a schematic view showing a configuration of an internal combustion engine according to a second embodiment; and

FIG. 9 is a schematic view showing a configuration of an internal combustion engine according to another embodiment.

### DETAILED DESCRIPTION

Multiple embodiments of an internal combustion engine will be described with reference to accompanying drawings. In each embodiment, the substantially same parts and the components are indicated with the same reference numeral and the same description will not be reiterated.

### First Embodiment

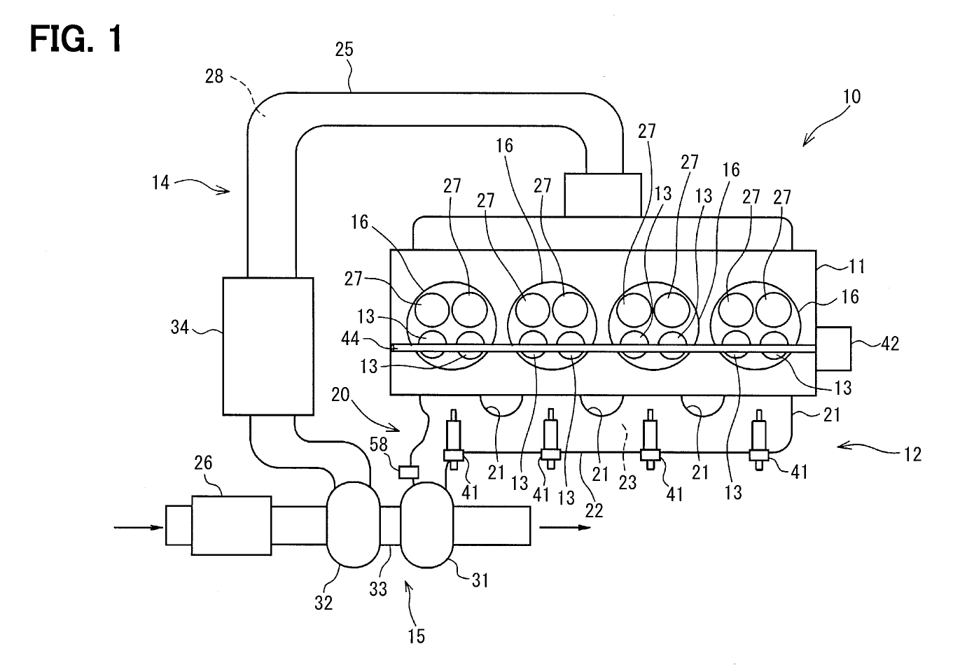

As shown in an FIG. 1, an internal combustion engine 10 is provided with an engine body 11, an exhaust system 12, an exhaust valve 13, an intake system 14, and a supercharger 15. The engine body 11 defines multiple combustion chambers 16. In the first embodiment, the internal combustion engine 10 is a 4-cylinder diesel engine. The engine body 11 has a cylinder block, a cylinder head, and a piston, which are not illustrated. The piston reciprocates in a cylinder which the cylinder block defines. The combustion chamber 16 is defined between the cylinder block, the cylinder head and the piston.

The exhaust system 12 has an exhaust pipe 20. The exhaust pipe 20 is comprised of branch pipes 21 and a collecting pipe 22. The exhaust pipe 20 defines an exhaust passage 23 therein. One end of each branch pipe 21 is connected to the combustion chamber 16 of an engine body 11. The other end of each branch pipe 21 is connected to the collecting pipe 22. One end of the exhaust passage 23 is connected to the combustion chamber 16, and the other end is opened to the atmosphere. The exhaust valve 13 opens and closes between the combustion chamber 16 and the exhaust passages 23. Specifically, the exhaust valve 13 opens and closes between the combustion chamber 16 and the exhaust passages 23 which the branch pipe 21 defines. When the exhaust valve 13 is opened, the exhaust gas discharged from the combustion chamber 16 is emitted to the atmosphere through the exhaust passage 23 which the branch pipe 21 and the collecting pipe 22 define.

The intake system 14 is provided with an intake pipe 25, an air cleaner 26 and an intake valve 27. The intake pipe 25 defines an intake passage 28 therein. One end of the intake passage 28 is opened to the atmosphere and the other end is connected to each combustion chamber 16. The air cleaner 26 removes foreign matters from intake air flowing through the intake passage 28. The intake valve 27 opens and closes between the combustion chamber 16 and the intake passage 28. When the intake valve 27 is opened, the intake air is introduced into the combustion chamber 16 through the intake passage 28.

The supercharger 15 has a turbine 31, a compressor 32, an axis 33, and an intercooler 34. The turbine 31 is provided in the exhaust passage 23. The compressor 32 is provided in the intake passage 28. The axis 33 connects the turbine 31 and the compressor 32. The turbine 31 is rotated by the exhaust gas flowing through the exhaust passage 23. The rotation of the turbine 31 is transferred to the compressor 32 through the axis 33. The compressor 32 is rotated by a driving force of the turbine 31. The intake air flowing through the intake passage 28 is pressurized by the compressor 32. The intercooler 34 cools the intake air of which temperature is increased due to pressurization by the supercharger 15.

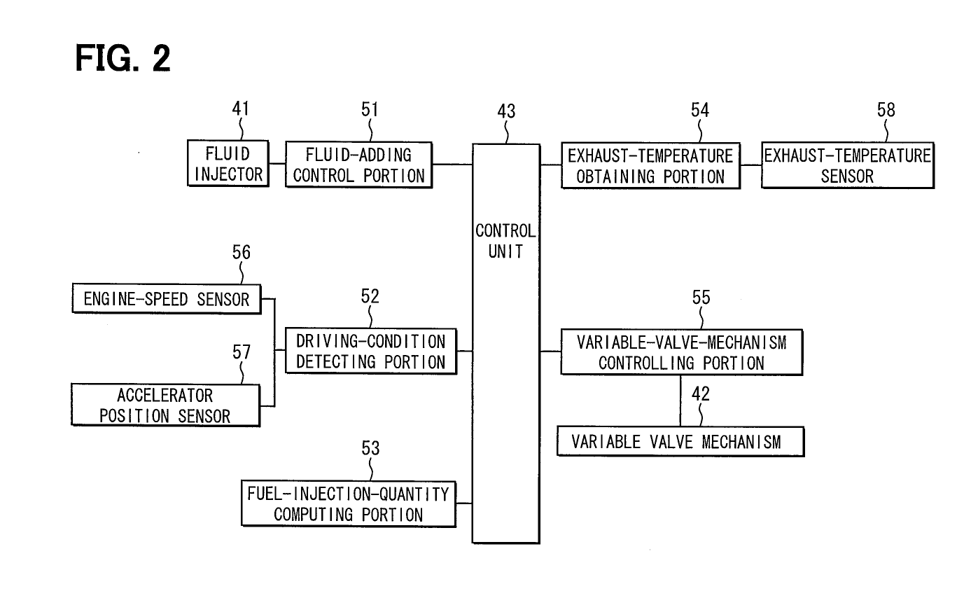

The internal combustion engine 10 of the first embodiment further includes a fluid injector 41 as a fluid-adding portion, a variable valve mechanism 42, and a control unit 43 shown in FIG. 2. The fluid injector 41 is arranged in the exhaust passage 23, as shown in FIG. 1. In the present embodiment, the fluid injector 41 is provided to each branch pipe 21. The fluid injector 41 is arranged downstream of the exhaust valve 13 in an exhaust gas flowing direction, and is arranged at a position close to the combustion chamber 16 in the exhaust passage 23. The fluid injector 41 injects non-combustible fluid containing water toward the exhaust gas flowing through the exhaust passage 23 defined by the branch pipe 21. Thus, the non-combustible fluid is added to the exhaust gas flowing through the exhaust passage 23, if needed. The non-combustible fluid is supplied from a fluid tank by a fluid pump, which are not illustrated. In the first embodiment, the non-combustible fluid is water containing unavoidable impurities. The non-combustible fluid is not limited to water. For example, the non-combustible fluid may be urea water or carbonated water.

The variable valve mechanism 42 varies at least one of the opening-and-closing phase angle, a working angle and a lift amount of the exhaust valve 13. The exhaust valve 13 is driven by a driving force transferred from a crankshaft, which is not illustrated. Specifically, the exhaust valve 13 is driven by a cam provided to a cam shaft 44. The cam shaft 44 receives a driving force from a crankshaft through a timing belt. The variable valve mechanism 42 changes the cam provided to the camshaft 44 or changes a cam-profile of the cam, so that the opening-and-closing phase angle, the working angle and the lift amount of the exhaust valve 13 are varied. It should be noted that the exhaust valve 13 is not limited to a valve which is mechanically driven by the driving force of the engine body 11. For example, the exhaust valve 13 may be driven by compressed air or oil pressure, or may be driven electromagnetically.

As shown in FIG. 2, a control unit 43 is mainly constructed of a microcomputer having a CPU, a ROM and a RAM. The control unit 43 executes control programs stored in the ROM, whereby a fluid-adding control portion 51, a driving-condition detecting portion 52, a fuel-injection-quantity computing portion 53, an exhaust-temperature obtaining portion 54, and a variable-valve-mechanism controlling portion 55 are realized. These fluid-adding control portion 51, the driving-condition detecting portion 52, the fuel-injection-quantity computing portion 53, the exhaust-temperature obtaining portion 54, and the variable-valve-mechanism controlling portion 55 may be configured by hardware, or software and hardware.

The fluid-adding control portion 51 is electrically connected to the fluid injector 41. The fluid injector 41 performs a water injection to the exhaust gas based on an electrical signal generated by the fluid-adding control portion 51. The fluid-adding control portion 51 controls a time point at which the fluid injector 41 injects the water into the exhaust gas flowing through the exhaust passage 23, and controls the water quantity to be injected.

The driving-condition detecting portion 52 is electrically connected to an engine-speed sensor 56 and an accelerator position sensor 57. The engine-speed sensor 56 detects a rotating speed of the crankshaft of the engine body 11. The engine-speed sensor 56 transmits electrical signals indicating the rotating speed of the crankshaft to the driving-condition detecting portion 52. The driving-condition detecting portion 52 computes a rotation angle of the crankshaft based on the rotating speed of the crankshaft detected by the engine-speed sensor 56. The accelerator position sensor 57 detects a stepped amount of an accelerator. The accelerator position sensor 57 transmits electrical signals indicating the stepped amount of the accelerator to the driving-condition detecting portion 52. A driving-condition detecting portion 52 detects a driving condition of the engine body 11, that is, a load of the engine body 11 based on the rotating speed of the crankshaft obtained by the engine-speed sensor 56, and the stepped amount of the accelerator obtained by the accelerator position sensor 57.

The fuel-injection-quantity computing portion 53 computes the injection quantity of the fuel supplied to the engine body 11 based on the driving condition of the engine body 11 detected by the driving-condition detecting portion 52. The engine body 11 has a fuel injector, which is not illustrated, to each combustion chamber 16, respectively. The fuel injector injects the fuel toward the intake air compressed in the combustion chamber 16, based on the injection quantity of the fuel computed by the fuel-injection-quantity computing portion 53. The fuel-injection-quantity computing portion 53 can correct the computed injection quantity of the fuel, based on the coolant temperature and the intake air temperature.

The exhaust-temperature obtaining portion 54 is electrically connected to an exhaust-temperature sensor 58. The exhaust-temperature sensor 58 is provided in the exhaust passage 23. The exhaust-temperature sensor 58 detects temperature of the exhaust gas flowing through the exhaust passage 23. The exhaust-temperature sensor transmits electrical signals indicating the exhaust gas temperature to the exhaust-temperature obtaining portion 54. The variable-valve-mechanism controlling portion 55 controls the variable valve mechanism 42 to drive the exhaust valve 13. That is, the variable-valve-mechanism controlling portion 55 changes the cam or the cam profile of the variable valve mechanism 42, whereby the opening-and-closing phase angle, the working angle and the lift amount of the exhaust valve 13 are controlled. The variable valve mechanism 42 and the variable-valve-mechanism controlling portion 55 correspond to an exhaust-valve control portion.

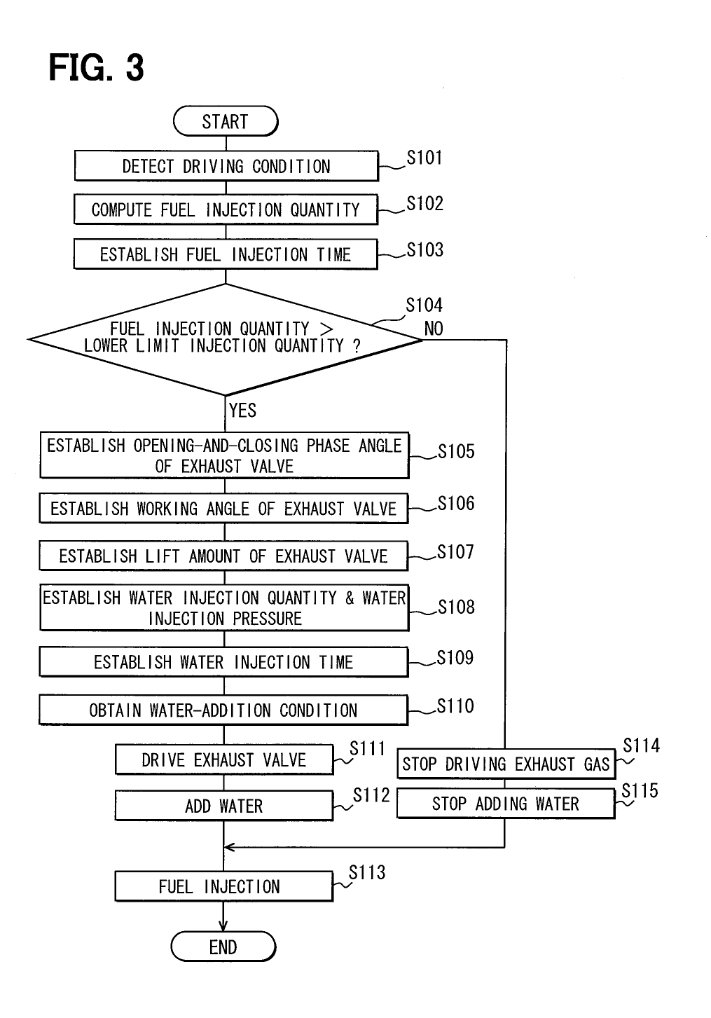

Referring to FIG. 3, an operation of the internal combustion engine 10 will be described hereinafter.

When the internal combustion engine 10 is driven, a driving-condition detecting portion 52 detects a driving condition of the engine body 11 (S101). Specifically, a driving-condition detecting portion 52 detects an engine speed with the engine-speed sensor 56 and an accelerator position with the accelerator position sensor 57. Thereby, the driving-condition detecting portion 52 obtains the driving condition, that is, a load condition of the engine body 11.

The fuel-injection-quantity computing portion 53 computes the injection quantity of the fuel supplied to the engine body 11 based on the driving condition of the engine body 11 detected by the driving-condition detecting portion 52 (S102). At this time, the fuel-injection-quantity computing portion 53 corrects the fuel injection quantity computed based on the coolant temperature and the intake air temperature. Moreover, the fuel-injection-quantity computing portion 53 establishes the time point at which the fuel is injected into each combustion chamber 16 of the engine body 11 (S103).

The fluid-adding control portion 51 determines whether the fuel injection quantity computed in S102 is greater than a predetermined lower limit injection quantity (S104). It is determined whether the fluid injector 41 should inject the water into the exhaust gas based on the driving condition of the engine body 11. That is, when the load of the internal combustion engine 10 becomes larger, the combustion temperature in the combustion chamber 16 is increased and NOx contained in an exhaust gas is increased. The load of the internal combustion engine 10 is correlated with the fuel injection quantity. As the load of the internal combustion engine 10 becomes larger, the fuel injection quantity is more increased. Therefore, the fuel injection quantity computed in S102 is correlated with the driving condition of the engine body 11, that is, the load of the internal combustion engine 10. Thus, the fluid-adding control portion 51 determines whether the fuel injection quantity computed in S102 is greater than the lower limit injection quantity.

When the answer is YES in S104, the variable-valve-mechanism controlling portion 55 establishes the opening-and-closing phase angle of the exhaust valve 13 for the intake stroke (S105), establishes the working angle of the exhaust valve 13 (S106), and establishes the lift amount of the exhaust valve 13 (S107). When the fuel injection quantity is larger than the lower limit injection quantity, the fuel quantity injected from the fuel injector to the combustion chamber 16 increases and the combustion temperature in the combustion chamber 16 rises. Therefore, when it is determined that the fuel injection quantity is larger than the lower limit injection quantity, the variable-valve-mechanism controlling portion 55 controls the variable valve mechanism 42 to vary the opening-and-closing phase angle, the working angle, and the lift amount of the exhaust valve 13. Specifically, a variable-valve-mechanism controlling portion 55 drives the exhaust valve 13 not only in the exhaust stroke but also in the intake stroke. The variable-valve-mechanism controlling portion 55 establishes the opening-and-closing phase angle, the working angle, and the lift amount of the exhaust valve 13 in the intake stroke. The opening-and-closing phase angle, the working angle, and the lift amount of the exhaust valve in the intake stroke are stored in the ROM as a map relating to the rotating speed of the crankshaft of an engine body 11 and the fuel injection quantity. The variable-valve-mechanism controlling portion 55 obtains the opening-and-closing phase angle, the working angle, and the lift amount of the exhaust valve 13 in the intake stroke based on the rotating speed of the crankshaft obtained in S101 and the fuel injection quantity computed in S102.

When the operating condition of the exhaust valve 13 in the intake stroke is established, the fluid-adding control portion 51 establishes the injection quantity and the injection pressure of the water which will be added to an exhaust gas through the fluid injector 41 (S108). The water injection quantity and the water injection pressure are stored in the ROM as a map relating to the rotating speed of the crankshaft of the engine body 11 and the fuel injection quantity. The fluid-adding control portion 51 establishes the water injection quantity and the water injection pressure which the fluid injector 41 injects, based on the rotating speed of the crankshaft obtained in S101 and the fuel injection quantity computed in S102.

The fluid-adding control portion 51 establishes a water injection time after establishing the water injection quantity and the water injection pressure (S109). The fluid-adding control portion 51 establishes the water injection time at which the fluid injector 41 injects the water toward the exhaust gas based on the opening-and-closing phase angle of the exhaust valve 13 in the intake stroke, which is established in S105. Then, the fluid-adding control portion 51 obtains a water-addition condition for adding the water (S110). Specifically, the fluid-adding control portion 51 obtains the exhaust-gas temperature detected by the exhaust-temperature sensor 58 from the exhaust-temperature obtaining portion 54. Thereby, the fluid-adding control portion 51 corrects the water injection quantity and the water injection pressure established in S108 and the water injection time established in S109, based on the water-addition condition, such as the exhaust-gas temperature.

When the various parameters for operating the exhaust valve 13 in the intake stroke and the various parameters for adding the water through the fluid injector 41 are established in S105 to S110, the variable-valve-mechanism controlling portion 55 controls the variable valve mechanism 42 to drive the exhaust valve 13 in the intake stroke (S111). The fluid-adding control portion 51 controls the fluid injector 41 to inject the water into the exhaust gas flowing through the exhaust passage 23 (S112). The fuel injector injects the fuel to the combustion chamber 16 in a last stage of the compression stroke or an early stage of the power stroke (S113).

Meanwhile, when the answer is NO in S104, the driving of the exhaust valve 13 in the intake stroke is stopped (S114), and the addition of the water from the fluid injector 41 is not conducted (S115). When the fuel injection quantity is not larger than the lower limit injection quantity, the fuel quantity injected from the fuel injector to the combustion chamber 16 decreases and the combustion temperature in the combustion chamber 16 drops. Therefore, when it is determined that the fuel injection quantity is not larger than the lower limit injection quantity, the variable-valve-mechanism controlling portion 55 controls the variable valve mechanism 42 to stop the driving of the exhaust valve 13 in the intake stroke. Moreover, when it is determined that the fuel injection quantity is below the lower limit fuel injection quantity, the fluid-adding control portion 51 terminates the water addition to the exhaust gas through the fluid injector 41.

With respect to a first cylinder among multiple cylinders of the engine body 11, the pressure in the combustion chamber 16, the condition of the water adding, and the operation conditions of the intake valve 27 and the exhaust valve 13 in the exhaust stroke, the intake stroke, the power stroke, and the expansion stroke will be explained.

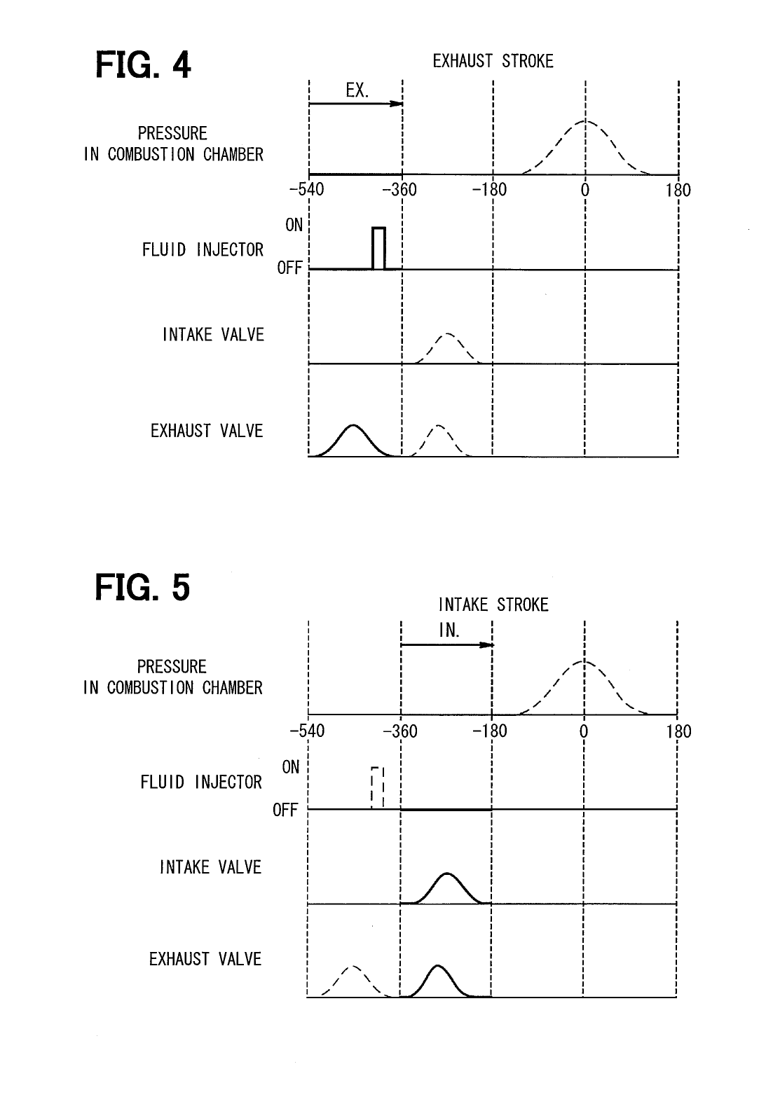

As shown in FIG. 4, when the first cylinder is in the exhaust stroke, the exhaust valve 13 opens between the combustion chamber 16 and the exhaust passages 23. That is, the exhaust valve 13 is “Open”. Meanwhile, the intake valve 27 closes between the combustion chamber 16 and the intake passage 28. That is, the intake valve 27 is “Close”. In the exhaust stroke, the piston slides up from a bottom dead center to a top dead center. The exhaust gas in the combustion chamber 16 is discharged to the exhaust passage 23. The fluid-adding control portion 51 transmits a command signal to the fluid injector 41 for adding the water at the last stage of the exhaust stroke. Thereby, the water is added to the exhaust gas flowing through the exhaust passage 23 in the last stage of an exhaust stroke. The added water is evaporated by the exhaust gas, and the evaporated water is contained in the exhaust gas as the steam. In a case that the non-combustible fluid contains the water, the water is evaporated by the exhaust gas to be contained in the exhaust gas. In the last stage of the exhaust stroke, the exhaust gas pressure discharged from the combustion chamber 16 is decreased as compared with that in the early stages of an exhaust stroke. The water injection pressure through the fluid injector 41 becomes relatively smaller. Therefore, the water supply portion including the fluid injector 41 for adding the water to the exhaust gas does not need a structure which can endure high pressure. The structure can be simplified.

As shown in FIG. 5, when the stroke of the first cylinder is shifted from the exhaust stroke to the intake stroke, the exhaust valve 13 closes between the combustion chamber 16 and the exhaust passages 23 once. That is, the exhaust valve 13 becomes “Close” at a time between the exhaust stroke and the intake stroke. Meanwhile, the intake valve 27 opens between the combustion chamber 16 and the intake passage 28. That is, the intake valve 27 is “Open”. In the intake stroke, the piston slides down from the top dead center to the bottom dead center. A fresh air is introduced into the combustion chamber 16 through the intake passage 28. At this moment, the opening-and-closing phase angle, the working angle, and the lift amount of the exhaust valve 13 are changed by the variable valve mechanism 42. After the exhaust valve 13 becomes “Close” once, the exhaust valve 13 opens between the combustion chamber 16 and the exhaust passages 23 again in the intake stroke. That is, the exhaust valve 13 becomes “Open” again. As a result, when the piston slides down, not only the intake air from the intake passage 28 but also a part of the exhaust gas from the exhaust passage 23 are introduced into the combustion chamber 16. As described above, in the last stage of the exhaust stroke, the water is added to the exhaust gas which is introduced into the combustion chamber 16 from the exhaust passage 23. Thereby, the exhaust gas returning to the combustion chamber 16 from the exhaust passage 23 contains the water vapor which is added by the fluid injector 41.

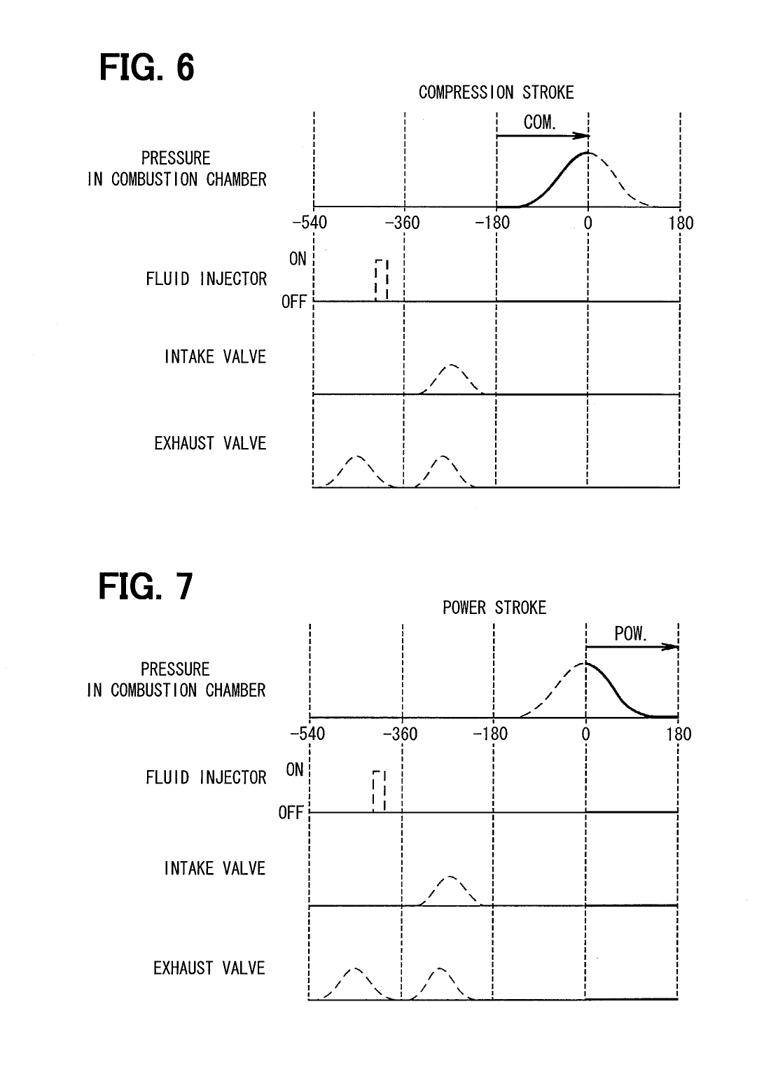

As shown in FIG. 6, when the stroke of the first cylinder is shifted from the intake stroke to the compression stroke, the intake valve 27 closes between the intake passage 28 and the combustion chamber 16 and the exhaust valve 13 closes between the combustion chamber 16 and the exhaust passages 23 once. That is, both the exhaust valve 13 and the intake valve 27 becomes “Close”. In the compression stroke, the piston slides up from the bottom dead center to the top dead center. The intake air and the exhaust gas containing the water vapor in the combustion chamber 16 are compressed. The pressure in the combustion chamber 16 is increased. The fuel injector injects the fuel toward the intake air compressed in the combustion chamber 16, when a piston is close to the top dead center. That is, the fuel is injected to the combustion chamber 16 immediately before or immediately after the piston reaches the top dead center.

The injected fuel is combusted in the combustion chamber 16. The piston slides down from the top dead center to the bottom dead center. Thereby, as shown in FIG. 7, the stroke of the first cylinder is shifted from the compression stroke to the power stroke. When it is in the power stroke, the intake valve 27 closes between the intake passage 28 and the combustion chamber 16, and the exhaust valve 13 closes between the combustion chamber 16 and the exhaust passages 23. That is, both the exhaust valve 13 and the intake valve 27 becomes “Close”. In the early stage of the power stroke, the fuel injected from the fuel injector is combusted in the combustion chamber 16. At this time, the exhaust gas containing the water vapor has been returned to the combustion chamber 16, as mentioned above. Therefore, the combustion temperature in the combustion chamber 16 is decreased due to the water vapor having large heat capacity. As a result, NOx contained in an exhaust gas can be reduced significantly.

According to the above first embodiment, the variable-valve-mechanism controlling portion 55 controls the variable valve mechanism 42 to adjust the opening-closing time of the exhaust valve 13. The exhaust valve 13 is opened not only in the exhaust stroke but also in the intake stroke. The combustion chamber 16 is fluidly connected to the exhaust passage 23 also in the intake stroke. Thereby, in the intake stroke, a part of the exhaust gas discharged from the combustion chamber 16 is returned to the combustion chamber 16 along with the intake air flowing through the intake passage 28. The fluid injector 41 is arranged downstream of the exhaust valve 13 in the exhaust gas flow direction. The fluid injector 41 injects the water to the exhaust gas discharged from the combustion chamber 16. Therefore, in the intake stroke, the exhaust gas introduced into the combustion chamber 16 from the exhaust passage 23 contains the water vapor. The exhaust gas immediately after discharged from the combustion chamber 16 to the exhaust passage 23 is of high temperature. Therefore, the water added from the fluid injector 41 is vaporized enough by the exhaust gas. Sufficient quantity of the vaporized water is introduced into the combustion chamber 16. The exhaust gas pressure in the exhaust passage 23 is lower than that in the combustion chamber 16. Thus, it is unnecessary to increase the water pressure to be added into the exhaust gas. The configuration of the water supply portion including the fluid injector 41 can be simplified.

Moreover, according to the first embodiment, the water added by the fluid injector 41 is introduced into the combustion chamber 16 along with the exhaust gas. That is, after the water is added to the exhaust gas, the exhaust gas is returned to the combustion chamber 16. Therefore, the water added to the exhaust gas is introduced into the combustion chamber 16 along with the exhaust gas in the intake stroke after the power stroke. The water decreases the combustion temperature in the power stroke after the water is added to the exhaust gas. Therefore, the water can be promptly added with high responsiveness according to the variation in fuel injection quantity and the variation in fuel combustion temperature.

As above, according to the first embodiment, the water added by the fluid injector 41 becomes the water vapor and is returned to the combustion chamber 16 with the exhaust gas. Therefore, the combustion temperature in the combustion stroke is decreased due to the water vapor having large heat capacity. The NOx contained in an exhaust gas can be reduced significantly.

According to the first embodiment, the water quantity added to the exhaust gas through the fluid injector 41 is established based on the fuel injection quantity injected by the fuel injector. Thus, the water quantity added to the exhaust gas is varied according to the load of the internal combustion engine 10. That is, as the fuel injection quantity is more increased, the water injection quantity is more increased. Thus, without respect to the load of the internal combustion engine 10, the NOx quantity contained in the exhaust gas can be accurately reduced.

According to the first embodiment, since the water quantity added to the exhaust gas from the fluid injector 41 is established based on the exhaust gas temperature, the added water is fully vaporized. All of the added water can be returned to the combustion chamber 16.

According to the first embodiment, at least one of the opening-and-closing phase angle, the working angle, and the lift amount of the exhaust valve 13 in the intake stroke is established based on the driving condition of the engine body 11. As the load of the internal combustion engine 10 becomes larger, the exhaust gas quantity returned to the combustion chamber 16 is more increased. Therefore, as the load of the internal combustion engine 10 becomes larger, it is necessary to prolong the valve opening period and to enlarge the lift amount of the exhaust valve 13. As the result, the exhaust gas of appropriate quantity can be returned to the combustion chamber 16 with the water according to the load of the internal combustion engine 10.

According to the first embodiment, the fluid injector 41 is arranged upstream of the supercharger 15 in the exhaust gas flow direction. The fluid injector 41 injects the water to the exhaust gas of high temperature, which has not passed through the supercharger 15 yet. Thereby, the vaporization of the injected water is accelerated. Especially, in the first embodiment, the fluid injector 41 is provided to the branch pipe 21 which is close to the exhaust valve 13. Therefore, the water injected by the fluid injector 41 is vaporized enough by the exhaust gas of high temperature immediately after the exhaust gas is discharged from the combustion chamber 16. In such a case that the fluid injector 41 is provided to the branch pipe 21, the fluid-adding control portion 51 controls the fluid injector 41 in such a manner that the fluid injector 41 injects the water before the exhaust valve 13 closes between the combustion chamber 16 and the exhaust passage 23 in the last stage of the exhaust stroke. In the last stage of an exhaust stroke, the exhaust gas discharged to the exhaust passage 23 from the combustion chamber 16 is kept at high temperature, and its pressure is decreasing. Therefore, the water supply portion including the fluid injector 41 does not need a structure which can endure high pressure. The structure can be simplified. In the last stage of the exhaust stroke, the flow velocity of the exhaust gas discharged from the combustion chamber 16 is decreased. Thus, the water injected by the fluid injector 41 remains around the fluid injector 41. As a result, when the exhaust valve 13 is opened in the intake stroke, the exhaust gas containing water vapor is returned to the combustion chamber 16. Furthermore, a distance between the fluid injector 41 provided to the branch pipe 21 and the combustion chamber 16 becomes shorter. Therefore, the exhaust gas to which the water is added in the exhaust stroke is promptly introduced into the combustion chamber 16 in the successive intake stroke. As the result, the exhaust gas to which the water is added decreases the combustion temperature in the successive power stroke. Therefore, the responsiveness to fuel injection quantity can be improved and NOx contained in the exhaust gas can be further reduced.

### Second Embodiment

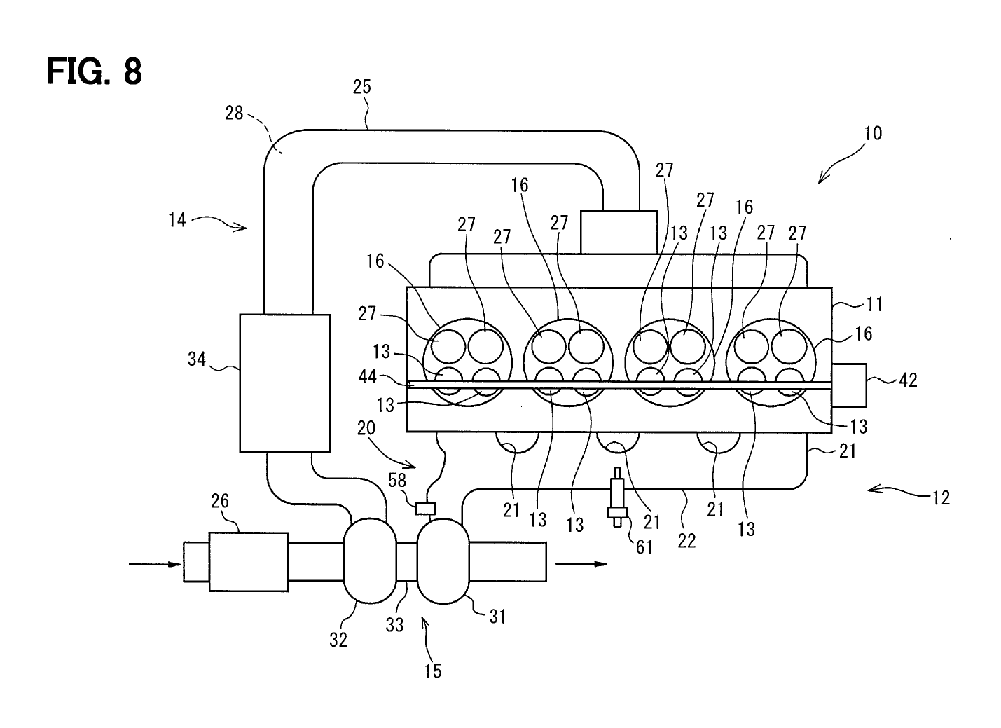

Referring to FIG. 8, a second embodiment of the internal combustion engine will be described.

In the second embodiment, the fluid injector 61 is provided to the collecting pipe 22. Thereby, the exhaust gas containing the water injected by the fluid injector 61 is returned to each of combustion chambers 16. The fluid injector 61 injects the water to the exhaust gas discharged from the combustion chamber 16. Therefore, the water injected by fluid injector 61 is vaporized enough by the exhaust gas.

In the second embodiment, the water is injected by the single fluid injector 61. Thus, the water injection time of the fluid injector 61 in the second embodiment is different from that in the first embodiment. In the second embodiment, the distance from each combustion chamber 16 to the fluid injector 61 is longer than that in the first embodiment. Therefore, it takes longer time for the exhaust gas containing the water to be returned to the combustion chamber 16 from the fluid injector 61. The fluid-adding control portion 51 drives the fluid injector 61, when each of the combustion chambers 16 is in the early stage or the middle stage of the exhaust stroke. Moreover, in a case that the engine body 11 has four cylinders, the fluid-adding control portion 51 controls the fluid injector 61 in such a manner that the fluid injector 61 injects the water when the crankshaft of the engine body 11 rotates 180 degree. Thereby, the exhaust gas containing the water injected by the fluid injector 61 is returned to each combustion chamber 16 in its intake stroke.

As described above, according to the second embodiment, the single fluid injector 61 injects the water into the exhaust gas. Therefore, the number of the fluid injector can be reduced as compared with the first embodiment, and its configuration can be simplified. Moreover, in the second embodiment, the water is added to the exhaust gas flowing through the collecting pipe 22. Therefore, the water added by the fluid injector 61 is vaporized enough by the exhaust gas of high temperature. The exhaust gas containing much water vapor can be returned to the combustion chamber 16.

### Other Embodiments

The present invention is not limited to the embodiment mentioned above, and can be applied to various embodiments.

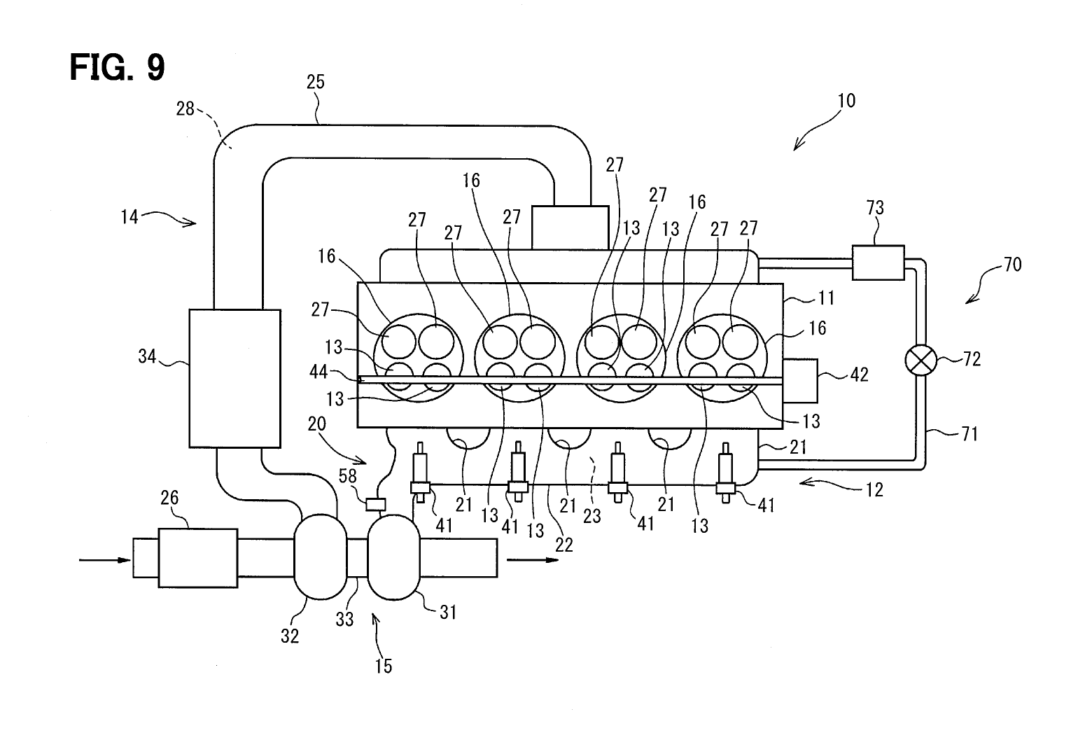

In the above-mentioned embodiments, the exhaust gas is returned to the combustion chamber 16 from the exhaust passage 23 by opening the exhaust valve 13 in the intake stroke. However, the internal combustion engine 10 may further have an external EGR system 70 as shown in FIG. 9. The EGR system 70 has an EGR pipe 71, an EGR valve 72, an EGR cooler 73, and the like. The EGR pipe 71 defines an EGR passage therein. One end of the EGR passage is connected to the exhaust passage 23 and the other end is connected to the intake passage 28. The EGR valve 72 is arranged in the EGR passage to adjust the intake air quantity which will be returned to the intake passage 28 through the EGR passage. The EGR cooler 73 cools the exhaust gas returning to the intake passage 28. As above, according to the internal combustion engine 10 provided with the external EGR system 70, the combustion temperature can be decreased by the exhaust gas returned through the external EGR system 70, in addition to the temperature decrease due to the added water.

In the above-mentioned embodiments, a 4-cylinder diesel engine is employed as the engine body 11. However, an engine body 11 is not limited to a 4-cylinder diesel engine. For example, an Otto-cycle engine can be employed.

What is claimed is:

1. An internal combustion engine, comprising:
an engine body defining a plurality of combustion chambers;
an exhaust system connected to the engine body for defining an exhaust passage through which an exhaust gas discharged from each of the combustion chambers flows;
an exhaust valve opening and closing between each of the combustion chambers and the exhaust passages;
a fluid-adding portion arranged downstream of the exhaust valve in an exhaust gas flow direction for adding a non-combustible fluid containing a water to the exhaust gas flowing through the exhaust passage;
an exhaust-valve control portion controlling an opening-and-closing time of the exhaust valve in such a manner that the exhaust valve is opened to fluidly connect the combustion chamber and the exhaust passages when the combustion chamber is in an exhaust stroke, and the exhaust valve is opened to fluidly connect the combustion chamber and the exhaust passages so as to return the exhaust gas including the non-combustible fluid into the combustion chamber when the combustion chamber is in an intake stroke; and
a fluid-adding control portion controlling an addition of the non-combustible fluid from the fluid-adding portion to the exhaust gas flowing through the exhaust passage.

2. An internal combustion engine, according to claim 1, further comprising:
a driving-condition detecting portion for detecting a driving condition of the engine body; and
a fuel-injection-quantity computing portion computing a fuel injection quantity based on the driving condition of the engine body detected by the driving-condition detecting portion, wherein
the fluid-adding control portion defines a quantity of the non-combustible fluid which is added from the fluid-adding portion to the exhaust gas, based on the fuel injection quantity computed by the fuel-injection-quantity computing portion.

3. An internal combustion engine, according to claim 1, further comprising:
an exhaust-temperature sensor detecting a temperature of the exhaust gas flowing through the exhaust passage, wherein
the fluid-adding control portion defines a quantity of the non-combustible fluid which is added from the fluid-adding portion to the exhaust gas, based on the temperature of the exhaust gas detected by the exhaust-temperature sensor.

4. An internal combustion engine, according to claim 2, wherein
the exhaust-valve control portion defines at least one of an opening-and-closing phase angle, a working angle and a lift amount of the exhaust valve, based on the driving condition of the engine body detected by the driving-condition detecting portion.

5. An internal combustion engine, according to claim 1, further comprising:
a supercharger supercharging an intake air which is introduced into the combustion chamber by the exhaust gas flowing through the exhaust passage, wherein
the fluid-adding portion is arranged between the engine body and the supercharger.

6. An internal combustion engine, according to claim 5, wherein
the exhaust system has branch pipes and a collecting pipe,
one end of the branch pipe is connected to each of the combustion chambers and another end of the branch pipe is connected to the collecting pipe, and
the fluid-adding portion is provided to each of the branch pipes.

7. An internal combustion engine, according to claim 6, wherein
the fluid-adding control portion controls the fluid-adding portion in such a manner that the fluid-adding portion injects the non-combustible fluid before the exhaust valve closes between the combustion chamber and the exhaust passage in a last stage of an exhaust stroke.

8. An internal combustion engine, according to claim 5, wherein
the exhaust system has branch pipes and a collecting pipe,
one end of the branch pipe is connected to each of the combustion chambers and another end of the branch pipe is connected to the collecting pipe, and
the fluid-adding portion is provided to the collecting pipe.

9. An internal combustion engine, according to claim 8, wherein
the fluid-adding control portion controls the fluid-adding portion in such a manner that the fluid-adding portion injects the non-combustible fluid after the exhaust valve opens between the combustion chamber and the exhaust passage in an early stage of an exhaust stroke.
